(19) United States
(12) Patent Application Publication
(10) Pub. No.: US 2026/0253110 A1
(43) Pub. Date: Aug. 27, 2026

(54) PRICE ESTIMATOR BUDGET

(71) Applicant: Carvana IPHC, LLC, Tempe, AZ (US)

(72) Inventors: Michael McGurk, Tempe, AZ (US); Gerald Daniel O'Neill, III, Tempe, AZ (US); Nicole Behrens, Tempe, AZ (US); Rodney Ellis, Tempe, AZ (US); Nicholas Hinkley, Tempe, AZ (US)

(21) Appl. No.: 19/060,383

(22) Filed: Feb. 21, 2025

(51) Int. Cl. G06Q 30/0283

(52) U.S. Cl. CPC G06Q 30/0283

(57) ABSTRACT

Determining a vehicle value estimate of a vehicle includes obtaining assessment input data associated with a vehicle, and applying the assessment input data to the vehicle assessment model. The vehicle assessment model includes a weighted vehicle attribute predictor model configured to generate a predicted set of vehicle attributes, a weighted vehicle value predictor model configured to generate an initial vehicle value prediction, and a macroeconomic data predictor model configured to predict macroeconomic data for a future target assessment date. The vehicle assessment model generates a vehicle assessment value for the future target assessment date based on a weighted combination of the predicted set of vehicle attributes, the initial vehicle value prediction, and the predicted macroeconomic data, and a conversion probability for the future target assessment date based on the weighted combination of the predicted set of vehicle attributes, the initial vehicle value prediction, and the predicted macroeconomic data.

### BACKGROUND

In recent years, the automotive industry has seen a significant shift towards the integration of advanced technologies to streamline the vehicle valuation process. Traditional methods of vehicle appraisal, which often relied heavily on manual inspections and subjective assessments, are increasingly being supplemented or replaced by sophisticated software tools and data analytics. This evolution not only enhances the efficiency of the appraisal process but also reduces the potential for human error and bias, thereby fostering greater trust and transparency in the market.

An example of these technologies in the automotive industry, buyers and sellers of vehicles often rely on guidebooks or tools that provide estimated values for vehicles based on historical transactions and other factors. One such tool is the Manheim Market Report (MMR), which is used as a benchmark for measuring the performance of wholesale transactions. MMR calculates a price range and a midpoint value for a given vehicle based on its year, make, model, trim, odometer, condition, region, color, and other attributes. MMR also provides an estimated retail value based on retail sales data, as well as samples of similar vehicles that are currently available or recently sold at wholesale auctions.

Despite the advancements in valuation tools, current methods still face limitations. Traditional guidebooks and tools often rely on historical data that may not reflect real-time market fluctuations or individual vehicle conditions. These tools can miss nuances such as recent changes in demand, regional economic factors, or unique vehicle features that impact valuation. As a result, there is a growing need for more dynamic and intelligent valuation.

### BRIEF DESCRIPTION OF THE DRAWINGS

For a detailed description of various examples, reference will now be made to the accompanying drawings in which:

FIG. 1 is a block diagram of an exemplary network system for determining a vehicle assessment value and a conversion probability, according to one or more embodiments.

FIG. 2 is a flowchart of an exemplary method of determining a vehicle assessment value and a conversion probability, according to one or more embodiments.

FIG. 3 is a flow diagram of an exemplary method of applying assessment input data to a vehicle assessment model, according to one or more embodiments.

FIG. 4 is a block diagram of an exemplary vehicle assessment model according to an embodiment of the disclosure.

FIG. 5A-5B show example interfaces for requesting a vehicle assessment value and a conversion probability, according to one or more embodiments.

FIG. 6 is a block diagram of an exemplary client device and an exemplary network device, according to one or more embodiments.

### DETAILED DESCRIPTION

The following description relates to technical improvements to generating assessment data for vehicles based on historic sales data, as well as market information. In addition, the following description provides a system and method for determining a vehicle assessment value and a conversion probability based on various data sources and machine learning techniques.

According to one or more embodiments, a vehicle assessment model is configured to receive assessment input data associated with a vehicle and generate a vehicle assessment value and a conversion probability for the vehicle. The assessment input data may include vehicle information, such as a vehicle identification number (VIN) of the vehicle, mileage of the vehicle, condition of the vehicle and the like. In some embodiments, the value prediction module may also intake one or more future target assessment dates. A future target assessment date may be a date in the future, such as within the next seven days, when the vehicle is expected to be sold or assessed, and may be determined automatically or based on user input.

The vehicle assessment model may include multiple weighted predictor models, each configured to generate predictive information from at least part of the assessment input data. Examples of weighted predictor models include a weighted vehicle attribute predictor model, a weighted vehicle value predictor model, and a macroeconomic data predictor model. The vehicle assessment model may generate a vehicle value prediction for the future target assessment date based on a weighted combination of the predicted set of vehicle attributes, the vehicle value prediction, and the predicted macroeconomic data. The vehicle assessment model may assign different weights to the outputs of the weighted vehicle attribute predictor model, the weighted vehicle value predictor model, and the macroeconomic data predictor model based on their relative importance and contribution to the assessment.

The vehicle assessment model may generate the conversion probability for the target assessment date or dates based on the weighted combination of the predicted set of vehicle attributes, the vehicle value prediction, and the predicted macroeconomic data. The conversion probability may be an estimated likelihood or percentage of the vehicle being sold at or above a particular assessment value on the future target assessment date.

Embodiments described herein provide a technical solution to problems arising from current automated vehicle valuation tools which rely on trailing averages of similar sales. In particular, embodiments described herein account for market fluctuations, rare vehicle types, and future market conditions by incorporating a machine learning model that leverages weighted outputs from multiple networks to generate assessment data for a future assessment date.

In the following description, numerous specific details are set forth to provide a thorough understanding of the various techniques. As part of this description, some of the drawings represent structures and devices in block diagram form. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flow diagram may be presented in a particular order. However, it should be understood that the particular flow of any flow diagram is used only to exemplify one embodiment. In other embodiments, any of the various components depicted in the flow diagram may be omitted, or the components may be performed in a different order or even concurrently. In addition, other embodiments may include additional steps not depicted as part of the flow diagram. Further, the various steps may be described as being performed by particular modules or components. It should be understood that the language used in this disclosure has been principally selected for readability and instructional purposes and may not have been selected to delineate or circumscribe the disclosed subject matter. As such, the various processes may be performed by alternate components than the ones described.

Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

### System for Vehicle Assessment

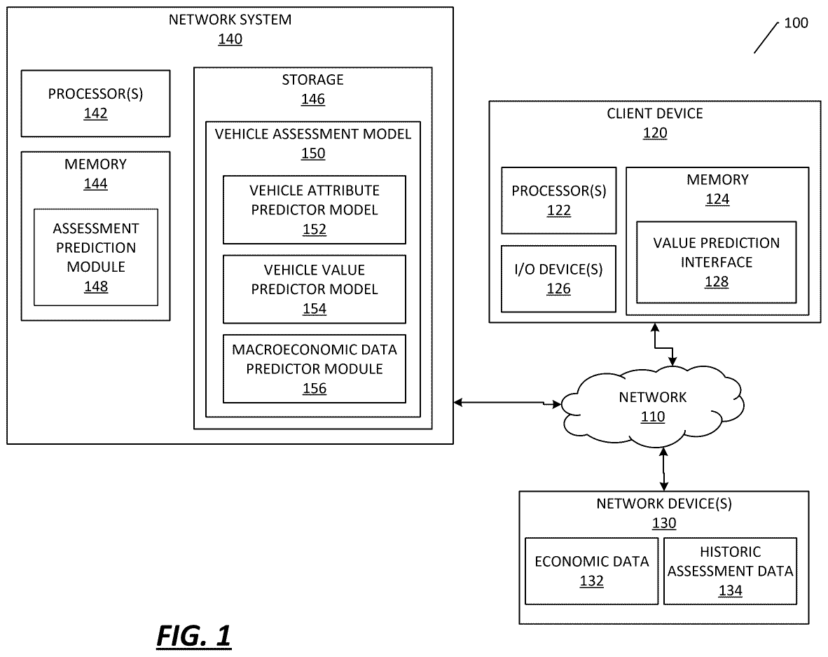

FIG. 1 depicts a network diagram of exemplary components for implementing a vehicle assessment prediction system, according to one embodiment of the disclosure. The network diagram 100 may include a client device 120, one or more network device(s) 130 and a network system 140 communicably connected across one or more networks, such as network 110. The network 110 may be any type of network, such as the Internet, a local area network (LAN), a wide area network (WAN), a cellular network, a wireless network, or a combination thereof, that enables communication among the client devices 120 and the network devices 130. The network 110 may include various network components, such as routers, switches, servers, firewalls, or other devices, that facilitate the transmission and routing of data packets. Although a particular representation of components and modules is presented, it should be understood that in some embodiments, the various components and modules may be differently distributed among the devices pictured, or across additional devices not shown.

The client device 120 may be any type of device capable of accessing the network 110 and communicating with the network device 130 and/or network system 140. The client device may be an electronic device, such as a personal computer, a laptop, a tablet, a smartphone, a wearable device, a smart TV, a gaming console, or any other device or system of devices with network connectivity. The client device 120 may include one or more processors 122, one or more memories 124, and one or more input/output (I/O) devices 126. The processor(s) 122 may be any type of processor, such as a central processing unit (CPU), a graphics processing unit (GPU), a microprocessor, a microcontroller, an application-specific integrated circuit (ASIC), a field-programmable gate array (FPGA), or any other processing device.

In some embodiments, the client device 120 may include additional components which are not shown, such as a network interface for connecting to devices across network 110, power supplies, and the like. The processor(s) 122 may be any processors, microprocessors, controllers, or other computing devices that can execute instructions or commands. Examples of processors include central processing units, graphical processing units, and the like. In addition, processor(s) 122 may include one or more processors of a same or different types. The I/O devices 126 may be any devices or components that can facilitate input or output operations for the client devices 120, such as keyboards, mice, touchscreens, displays, speakers, microphones, cameras, or other devices.

Memory 124 may be any non-transitory computer readable media, such as random-access memory (RAM), read only memory (ROM), flash memory, hard disk, solid state drive, or other media. In some embodiments, memory 124 may store computer readable code executable by processor(s) 122 to perform actions described herein.

According to one or more embodiments, memory 124 may include value prediction interface 128. Value prediction interface 128 may include a user interface, such as a graphical user interface, through which a user can request assessment of a vehicle and provide user input from which the vehicle assessment data can be generated. The value prediction interface 128 may include a graphical user interface (GUI) that displays various input fields, output fields, buttons, menus, icons, or other graphical elements that enable the user to enter assessment input data for a vehicle, such as a vehicle identification number (VIN), mileage, condition, location, target assessment date, drivable indicator, desired floor price, or any other data associated with the vehicle or the assessment. The assessment input data may be received via an I/O device(s) 126, such as a keyboard, mouse, microphone, and the like. The value prediction interface 128 may also display the vehicle assessment value and the predicted conversion probability, as well as other information, such as vehicle attributes, historical sales data, market trends, or any other information related to the vehicle or the assessment. The vehicle assessment value may be presented on an I/O device(s) 126, such as a display.

The network device(s) 130 may be any type of device capable of hosting and providing the vehicle assessment prediction system, such as a server, a cloud computing platform, a distributed computing system, network storage, or any other device with network connectivity. The network device(s) 130 may be configured to host data relevant to vehicle assessments, such as economic data 132 and historic assessment data 134. Economic data 132 and historic assessment data 134 may each include data stored on one or more computer readable media, for example in one or more data structures. The economic data 132 may include any data related to the macroeconomic factors that may affect the vehicle value, such as petroleum prices, auto inventory or sales ratio, consumer price index for preowned vehicles, an average preowned vehicle loan amount, net purchases of preowned vehicles, or any other economic data. The economic data 132 may be obtained from various sources, such as the Federal Reserve Economic Data (FRED) API, or any other source. The historic assessment data 134 may include any data related to the past transactions of vehicles, marketplaces, or other points of sale. The historic assessment data 134 may include data such as historic vehicle attributes, vehicle conditions, vehicle locations, sale dates, sale prices, vehicle histories, or any other data. The historic assessment data 134 may be obtained from various sources, such as one or more databases or other data structures hosted by one or more parties. The network device(s) may also store other types of data, such as user data, vehicle data, model data, or any other data.

The network system 140 includes one or more processors 142, one or more memories 144, and storage 146. The memory 144 may store one or more applications that can be executed by the processor 142 to perform various functions on the network system 140. For example, the memory 144 may include computer readable code for an assessment prediction module 148 that implements the vehicle assessment prediction system. The assessment prediction module 148 may use a vehicle assessment model 150 that predicts a vehicle assessment value and a conversion probability for a vehicle based on assessment input data and various predictive models that incorporate vehicle attributes, assessment data, and macroeconomic data. The vehicle assessment model 150 is shown within storage 146, and may include computer readable code for predicting vehicle assessment data, including one or more vehicle values and corresponding conversion predictions. In some embodiments, the vehicle assessment model 150 includes one or more smaller models, such as a vehicle attribute predictor model 152, configured to predict vehicle attributes relevant to vehicle assessment, a vehicle value predictor model 154, configured to generate a vehicle value prediction, and a macroeconomic data predictor module 156 configured to predict macroeconomic data at a given time. According to one or more embodiments, the vehicle attribute predictor model may be configured to predict vehicle characteristics. For example, the vehicle attribute predictor model may analyze vehicle data to classify or normalize vehicle attributes, such as trim classification or the like. In some embodiments, the vehicle assessment model 150 may be configured to use a combination of the predictor models to determine assessment data. In some embodiments, the vehicle assessment model may weigh the smaller models in determining assessment data for a vehicle. Further, in some embodiments, the vehicle assessment model 150 may be trained on training data from predefined assessments. In some embodiments, the vehicle assessment model may incorporate a weighted component associated with a seasonality of the training data.

### Value Estimate Determination

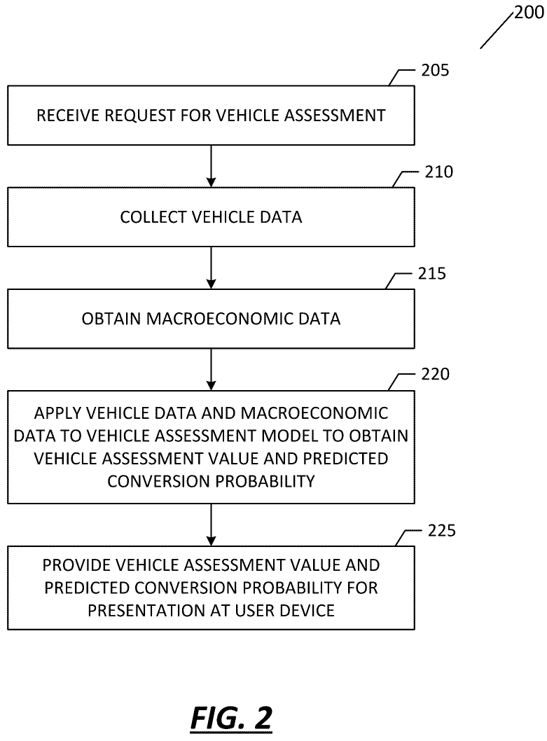

FIG. 2 is a flow diagram of an exemplary method 200 of determining a vehicle value estimate of a vehicle, according to one embodiment of the disclosure. In particular, FIG. 2 depicts an overall technique for determining assessment information for a vehicle in accordance with one or more embodiments. For purposes of explanation, the following steps will be described as being performed by particular components and with reference to FIG. 1. However, it should be understood that the various actions may be performed by alternate components. In addition, the various actions may be performed in a different order. Further, some actions may be performed simultaneously, some may not be required, or others may be added.

The flowchart 200 begins at block 205, where the technique includes receiving a request for vehicle assessment. The request may be received through a value prediction interface on a client device 120, such as a desktop computer, laptop, tablet, smartphone, or other smart device or network-connected device. The user making the request could be a buyer, seller, or any other stakeholder in the vehicle market, including individual buyers and sellers, agents within a wholesale market, or the like. The request may include user input data for a vehicle for which assessment data is requested. Examples of input data include a vehicle identification number (VIN) of a target vehicle, mileage of the vehicle, and condition of the vehicle, drivable indicator, desired floor price, and the like. In some embodiments, the assessment input data may include contextual information for the assessment, such as a target sales or assessment date, location, and the like. The assessment input data may also include other data to predict its value and conversion probability at one or more future target assessment dates.

The flowchart 200 proceeds to block 210, where the technique includes collecting vehicle data based on request. The vehicle data may include any data related to the vehicle attributes, and may be collected from one or more sources. In some embodiments, the vehicle data may include the user input data, and/or may include data derived from the user input data. Examples of vehicle data include a year, make, model, trim, color, original value, or any other attribute. In some embodiments, at least some of the vehicle data may be collected from the user interface from which the request is received. Additionally, or alternatively, the vehicle data may be received from one or more remote sources, and may be collected based on data received via the interface, or predefined data associated with the user and available to the requesting device. For example, a third-party provider may decode a VIN provided in the request and provide the vehicle attributes and other assessment data available for the VIN.

At block 215, the flowchart 200 includes obtaining macroeconomic data. According to one or more embodiments, obtaining macroeconomic data involves collecting data related to various economic factors that may influence vehicle values. This data includes petroleum prices, auto inventory or sales ratios, the consumer price index for preowned vehicles, the average preowned vehicle loan amount, and net purchases of preowned vehicles. The macroeconomic data can be sourced from reliable databases such as the Federal Reserve Economic Data (FRED) API, which provides comprehensive and up-to-date economic information.

The flowchart 200 proceeds to block 220, where the technique includes applying the assessment input data to the vehicle assessment model to obtain the vehicle assessment value and the predicted conversion probability. The vehicle assessment model may include various predictive models that incorporate vehicle attributes, assessment data, and macroeconomic data, as described in more detail below. The vehicle assessment model may generate a vehicle assessment value for one or more future target assessment dates based on a weighted combination of the predicted set of vehicle attributes, the vehicle value prediction, and the predicted macroeconomic data. The vehicle assessment model may also generate a conversion probability for the target assessment date based on the weighted combination of the predicted set of vehicle attributes, the vehicle value prediction, and the predicted macroeconomic data.

The flowchart 200 concludes at block 225, where the vehicle assessment value and the predicted conversion probability are provided for presentation, for example at the client device 120. The vehicle assessment value and the predicted conversion probability may be provided via the value prediction interface, or via any other interface. The vehicle assessment value and the predicted conversion probability may be presented in various formats, such as numerical values, graphical elements, charts, tables, or any other format. The vehicle assessment value and the predicted conversion probability may also be accompanied by other information, such as vehicle attributes, historical sales data, market trends, or any other information related to the vehicle or the assessment.

### Vehicle Assessment Model

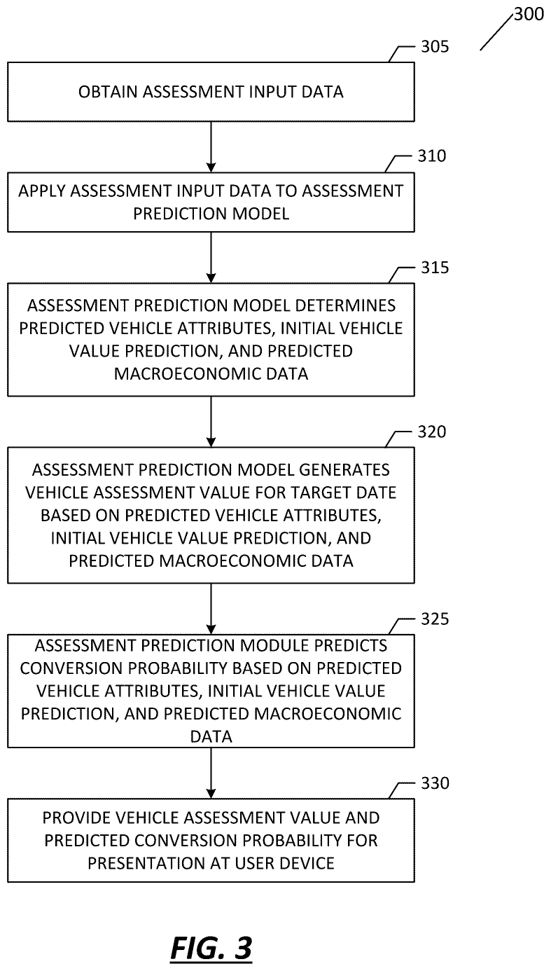

FIG. 3 includes a flow diagram of an exemplary method 300 of applying assessment input data to a vehicle assessment model, according to one embodiment of the disclosure. For purposes of explanation, the following processes will be described as being performed by particular components and with reference to FIG. 1. However, it should be understood that the various actions may be performed by alternate components. In addition, the various actions may be performed in a different order. Further, some actions may be performed simultaneously, some may not be required, or others may be added.

The flowchart 300 begins at block 305 by obtaining assessment input data. According to one or more embodiments, the assessment input data may include data identifying the vehicle that is the target of the assessment. For example, the assessment input data may include a vehicle identification number (VIN) of the vehicle, mileage of the vehicle, vehicle condition or drivability, and the like. In addition, the assessment input data may include context information for the assessment, such as a future date and/or location. The future target assessment date may be any date in the future, for example within a predetermined time period, such as 14 days, from the current date. Additionally, or alternatively, the assessment input data may include a set or range of future dates, and may be determined automatically based on a date on which the assessment request is received.

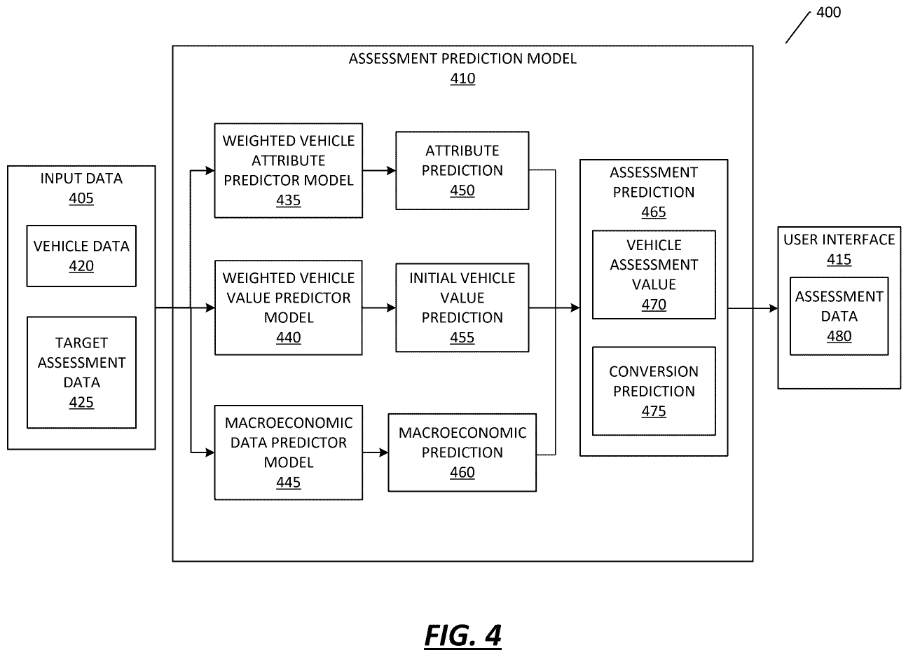

Turning to FIG. 4, a flow diagram for using a vehicle assessment model 410 to determine assessment data. It should be understood that the various components of the flow diagram 400 in FIG. 4 are intended for example purposes. Some embodiments may be differently constructed, or may perform the various processes in a different order. With respect to the assessment input data, input data 405 includes vehicle data 420 and target assessment data 425. In some embodiments, the assessment input data may be obtained from one or more sources, and may be obtained from user input, a local source, a remote source, or a combination thereof. For example, vehicle data 420 may include user input such as a make and model of a vehicle, a VIN number, condition information, and other data. In some embodiments, vehicle data may include data derived from user input data. For example, if a user provides a VIN number, a third-party service may be used to determine vehicle attributes that correspond to the VIN number. Target assessment data 425 may include data related to a context of the assessment, such as a target date or target timeline for the assessment, location information, user-defined desired floor price, and the like. In some embodiments, at least some of the target assessment data may be retrieved from a remote source, such as macroeconomic data, target assessment date, or the like.

Returning to FIG. 3, the flowchart 300 continues to block 310, where assessment input data is applied to the vehicle assessment model. The vehicle assessment model may include various predictive models that incorporate vehicle attributes, assessment data, and macroeconomic data. The vehicle assessment model may use machine learning technique or a combination thereof, such as a linear regression, a logistic regression, or a random forest, to predict the assessment value based on the assessment input data and/or the vehicle data. The vehicle assessment model may assign different weights to different predictive data based on their importance or relevance to the vehicle value. For example, the expected sale price, the expected sale date, the expected sale location, the expected sale channel, and the expected sale condition may have higher weights than other vehicle data. The weighted vehicle value prediction model may output the initial vehicle value prediction as a vector of values, such as a numerical vector or a probability vector, that represents the vehicle value data. In some embodiments, the weighted vehicle value prediction model may predict a value based on one or more parameters, such as vehicle depreciation, historical vehicle attributes, market performance of other vehicles, seasonality of assessments of other vehicles, location for the assessment, and/or target assessment date.

Returning to FIG. 4, the assessment input data, represented as input data 405, is input into the vehicle assessment model 410. The input data 405 may be applied to the vehicle assessment model 410, and in particular, the smaller models used by the vehicle assessment model 410, such as the weighted vehicle attribute predictor model 435, the weighted vehicle value predictor model 440, and the macroeconomic data predictor model 445. According to one or more embodiments, each of the predictor models within the vehicle assessment model 410 may use at least some of the input data 405 and may not use all of the input data 405 in generating predictive data.

Each of the predictive models may generate prediction output that may be used to generate the assessment data. Returning to FIG. 3, the flowchart 300 proceeds to block 315, where the vehicle assessment model determines predicted vehicle attributes, the vehicle value prediction, and predicted macroeconomic data. As shown in FIG. 4, the weighted vehicle attribute predictor model 435 generates an attribute prediction 450 (i.e., the predicted vehicle attributes). The weighted vehicle value predictor model 440 generates an initial vehicle value prediction 455 (i.e., the predicted vehicle value data). Finally, the macroeconomic data predictor model 445 generates a macroeconomic prediction 460 (i.e., the predicted macroeconomic data). According to one or more embodiments, the macroeconomic data predictor model 445 may predict the macroeconomic data based on one or more parameters, such as petroleum prices, auto inventory, consumer price index for preowned vehicles, average preowned vehicle loan amount, net purchase of preowned vehicles, or the like.

The flowchart 300 of FIG. 3 proceeds to block 320, the vehicle assessment model generates the vehicle value estimate for the future target assessment date based on the weighted combination of the predicted set of vehicle attributes, the vehicle value prediction, and the predicted macroeconomic data. According to one or more embodiments, the value prediction module may use a machine learning technique, such as a neural network, a decision tree, or a support vector machine, to combine the predicted set of vehicle attributes, the vehicle value prediction, and the predicted macroeconomic data into one or more values that represent the vehicle value estimate for a particular time or time period.

According to one or more embodiments, the vehicle assessment model may use the output of the smaller predictive models in predicting the vehicle assessment value. For example, the vehicle assessment model may assign different weights to the predicted set of vehicle attributes, the vehicle value prediction, and the predicted macroeconomic data based on their importance or relevance to the vehicle value, and/or for the particular target assessment date or time period. The vehicle assessment value may indicate the expected sale price of the vehicle at the future target assessment date. The weights may be determined based on various factors, such as the importance, reliability, or accuracy of each output. In some embodiments, the predicted set of vehicle attributes may have a higher weight than the vehicle value prediction, and the vehicle value prediction may have a higher weight than the predicted macroeconomic data. The value prediction module may output a value for a particular date, or a set of values corresponding to a set of dates. For example, the vehicle assessment model may be configured to generate predictive data for a predetermined future time frame based on an incoming request, based on user input, or the like. In some embodiments, the vehicle assessment model may utilize a heuristic technique to determine the vehicle value prediction.

The flowchart proceeds to block 325, where the value prediction module predicts a conversion probability for the target assessment date or dates based on the weighted combination of the predicted set of vehicle attributes, the vehicle value prediction, and the predicted macroeconomic data. The conversion probability may indicate the likelihood of the vehicle being sold at or above a vehicle assessment value at the target assessment date. The weights may be determined based on various factors, such as the importance, reliability, or accuracy of each output. The vehicle assessment model may use a machine learning technique, such as a logistic regression, a random forest, or a neural network, to combine the predicted set of vehicle attributes, the vehicle value prediction, and the predicted macroeconomic data into one or more values that represents the conversion probability. In some embodiments, the vehicle assessment model may utilize a heuristic technique, such as a predefined algorithm for determining the predictive conversion probability. The vehicle assessment model may predict the conversion probability as a percentage that represents the likelihood of the vehicle being sold at or above the vehicle value estimate at the target assessment date. In the example of FIG. 4, the vehicle assessment model 410 generates an assessment prediction 465 based on the attribute prediction 450, initial vehicle value prediction 455, and macroeconomic prediction 460. The assessment prediction includes a vehicle assessment value 470, as well as a conversion prediction 475 for that vehicle value. According to some embodiments, the vehicle assessment value 470 may be the same or different from the initial vehicle value prediction 455. In some embodiments, the vehicle assessment value 470 may be modified from the initial vehicle value prediction 455 based on the additional factors, such as the attribute prediction 450 and/or the macroeconomic prediction 460.

The flowchart 300 of FIG. 3 concludes at block 330, where the vehicle assessment value and predicted conversion probability are provided for presentation at a user device. The vehicle assessment value and the predicted conversion probability may be provided via the value prediction interface, or via any other interface. The vehicle assessment value and the predicted conversion probability may be presented in various formats, such as numerical values, graphical elements, charts, tables, or any other format. The vehicle assessment value and the predicted conversion probability may also be accompanied by other information, such as vehicle attributes, historical sales data, market trends, or any other information related to the vehicle or the assessment. Thus, as shown in FIG. 4, the assessment prediction 465 is used to populate the assessment data 480 presented in user interface 415.

### Example User Interface

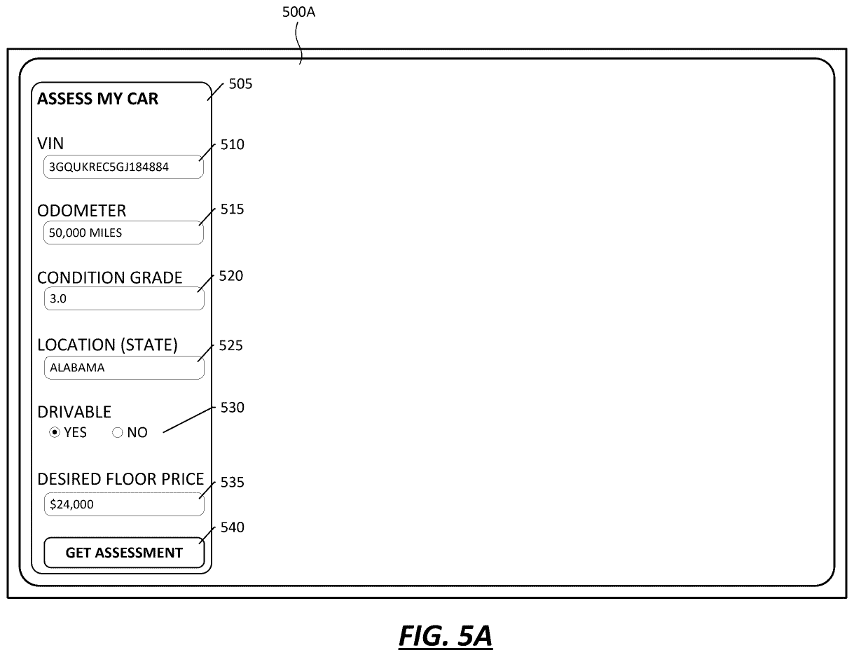

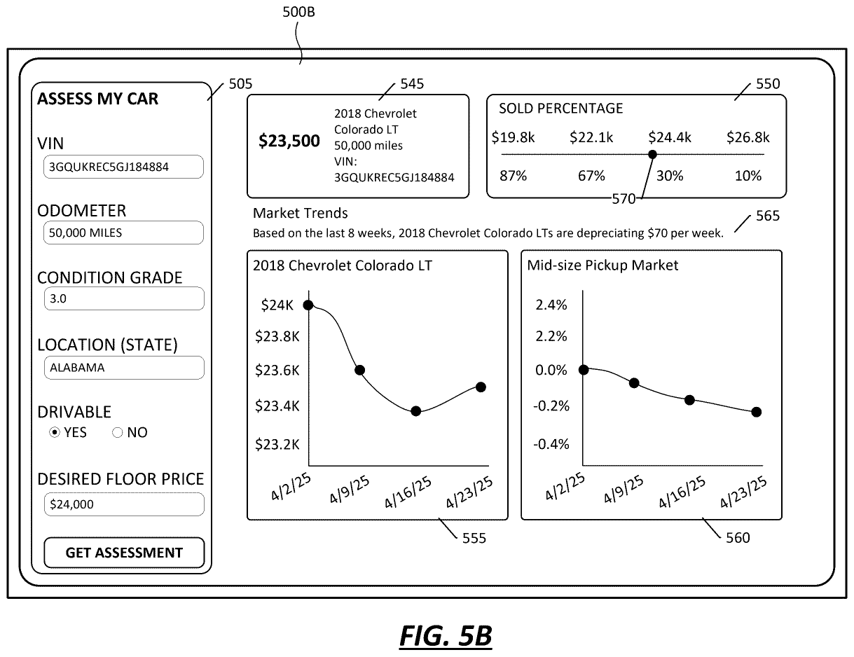

FIGS. 5A-5B show screenshots of an example user interface by which assessment input can be received from a user, and which can provide resulting vehicle assessment data, according to one or more embodiments. In particular, FIGS. 5A-5B depicts an example user interface for receiving input and resulting data generated from a vehicle assessment model. For purposes of explanation, the following steps will be described as being performed by particular components. However, it should be understood that the various actions may be performed by alternate components. In addition, the various actions may be performed in a different order. Further, some actions may be performed simultaneously, some may not be required, or others may be added.

Turning to FIG. 5A, a user interface 500A is presented. The user interface 500A includes various input fields, output fields, buttons, menus, icons, or other graphical elements that enable the user to enter assessment input data, such as value prediction interface 128 of client device 120 of FIG. 1. In the example shown as user interface 500A, a user input panel 505 is provided. The user input panel 505 may be presented as a separate window or section of a user interface, and may include one or more user input components, for example in the form of input fields. These input fields may include a vehicle identification number (VIN), mileage, condition, location, target assessment date, drivable indicator, desired floor price, or any other data associated with the vehicle or the assessment. In some embodiments, at least some of the information may be automatically entered, for example based on a current user profile and known vehicle, a vehicle that has previously been identified prior to the user interface being provided, or the like.

In the example shown, the user input panel 505 includes a VIN input component 510, in which a user can enter a VIN for a vehicle of interest. The user input panel includes an odometer input component 515, by which a user can provide an odometer reading for the vehicle of interest. According to one or more embodiments, the odometer input component 515 may include a text box in which a user can enter odometer data for the vehicle of interest. Alternatively, the odometer input component 515 may provide a drop-down menu or other selectable input component by which a user can select a range of mileage values corresponding to the vehicle of interest. The user input panel 505 also includes condition grade input component 520, by which a user can provide an indication of a condition of the vehicle of interest. According to one or more embodiments, the condition grade input component 520 may include a text box in which a user can enter a condition grade for the vehicle of interest. Alternatively, the condition grade input component 520 may provide a drop-down menu or other selectable input component by which a user can select a condition grade corresponding to the vehicle of interest. In addition, the user input panel 505 includes a location input component 525, by which a user can indicate where the vehicle is located and/or where the assessment of the vehicle is to occur. According to one or more embodiments, the location input component 525 may include a text box in which a user can enter location information, such as a state. Alternatively, the location input component 525 may provide a drop-down menu or other selectable input component by which a user can select a location for the assessment. A drivable indicator 530, may correspond to an input component by which the user can indicate whether the vehicle of interest is drivable or not, such as by selecting a checkbox or a radio button. A desired floor price input field 535 is provided by which the user can enter the desired floor price of the vehicle of interest, such as the minimum price that the user is willing to accept or pay for the vehicle. According to one or more embodiments, the floor price input field 535 may include a text box in which a user can enter a monetary value.

Alternatively, the floor price input field 535 may provide a drop-down menu or other selectable input component by which a user can select a monetary value corresponding to a target assessment of the vehicle of interest. The user input panel 505 also includes a submit button 540, which acts as a user input component by which a user can transmit the entered assessment data for processing. It should be understood that the various input components described within the user input panel 505 are intended to be example input components, and alternative or additional components may be included in some embodiments. Further, not all components may be provided in the user input panel 505 in accordance with some embodiments.

Upon selection of the submit button 540, the input data may be provided to an assessment prediction module which may use the input data and/or additional retrieved data from the local device or a remote device, to generate predicted assessment data, such as price, conversion prediction, and the like. In some embodiments, the local device, such as client device 120, may retrieve additional data necessary (for example, from network device(s) 130), and/or may execute an assessment prediction module locally to obtain assessment data. Additionally, or alternatively, the local device, such as client device 120, may transmit the entered data to a remote device, such as network system 140 hosting the assessment prediction module 148, which may then optionally retrieve additional data, for example from network device(s) 130, and/or apply the assessment data to the vehicle assessment model 150 to obtain the assessment data.

Turning to FIG. 5B, the user interface 500B displays the assessment results, which may be determined locally, or may be received from a remote system, such as network system 140. The user interface 500B shows the user input panel 505 from FIG. 5A, and in addition, shows prediction data. The prediction data may include one or more components showing different categories of assessment data. According to one or more embodiments, the user interface 500B includes a vehicle assessment section 545, where the user can see the vehicle value estimate for the vehicle of interest, based on the assessment input data, the vehicle data, and the macroeconomic data. Accordingly, the vehicle assessment section 545 includes additional data for the vehicle, which may be retrieved from a third party based on the assessment input, such as the VIN. The vehicle value estimate may be a dollar amount that represents the expected sale price of the vehicle. The vehicle value estimate may correspond to a particular target date, or may be an average, median, or other value based on a target date range.

A conversion prediction section 550 shows a predicted chance of conversion for the target vehicle, for example at the predicted value or values, and/or the target assessment date or date range. The range of possible values may be displayed as a horizontal bar with different colors or shades, and the associated percentages may be displayed as numbers or labels above or below the bar. The percentages may represent the conversion expected for the vehicle at or above the shown price. For example, the conversion prediction section 550 shows that the vehicle has a 87% chance of being sold at or above $19.8k, a 67% chance of being sold at or above $22.1k, a 30% chance of being sold at or above $24.4k, and a 10% chance of being sold at or above $26.8k. The conversion prediction section 550 also shows an indicator 570 that represents the desired floor price that was entered, if any. For example, the conversion prediction section 550 indicates that the desired floor price of $24k is within the range of possible values, and has a 30% chance of being sold at or above that price.

According to one or more embodiments, the user interface 500B includes a valuation section 555. The valuation section may indicate the change in valuation for the vehicle of interest over a time period that includes the target date or date range. The graph may include a horizontal axis that represents the time, such as weeks, months, target dates, or the like. The graph may also include a vertical axis that represents the valuation, such as dollars or other currency. The graph may include a line or a curve that represents the valuation of the vehicle of interest over time, and may include a point or a marker that represents the current valuation of the vehicle of interest, which may correspond to the vehicle value estimate shown in the vehicle assessment section 545. The graph may also include a legend or a label that identifies the vehicle of interest by its year, make, model, and trim. For example, the valuation section 555 indicates that the valuation of the 2018 Chevrolet Colorado LT is predicted to decrease from about $24k to about $23.4k, before increasing to about $23.5k.

According to one or more embodiments, the user interface 500B also includes a vehicle segment performance component 560 in the form of a graph. The vehicle segment performance component shows the percentage change in depreciation of the specific vehicle segment of the vehicle of interest over the selected period, based on the vehicle assessment data. The graph may include a horizontal axis that represents the time, such as weeks, months, target dates, or the like. The graph may also include a vertical axis that represents the percentage change in depreciation, such as percentages. The graph may include a line or a curve that represents the percentage change in depreciation of the vehicle segment over time. In some embodiments, the graph may include an additional component that represents a specific target date or range as indicated by the user. The graph may also include a legend or a label that identifies the vehicle segment of the vehicle of interest, such as a category or a type.

In some embodiments, the user interface 500B also includes a market trends section 565. The market trends section may include data indicative of an overall assessment for future predictive value of the vehicle. The summary may include the amount and the direction of the depreciation or appreciation, and the period of time over which it is predicted to occur. For example, market trends section 565 indicates that the vehicle is predicted to depreciate $70 per week based on data over the last 8 weeks.

### Example Electronic Device

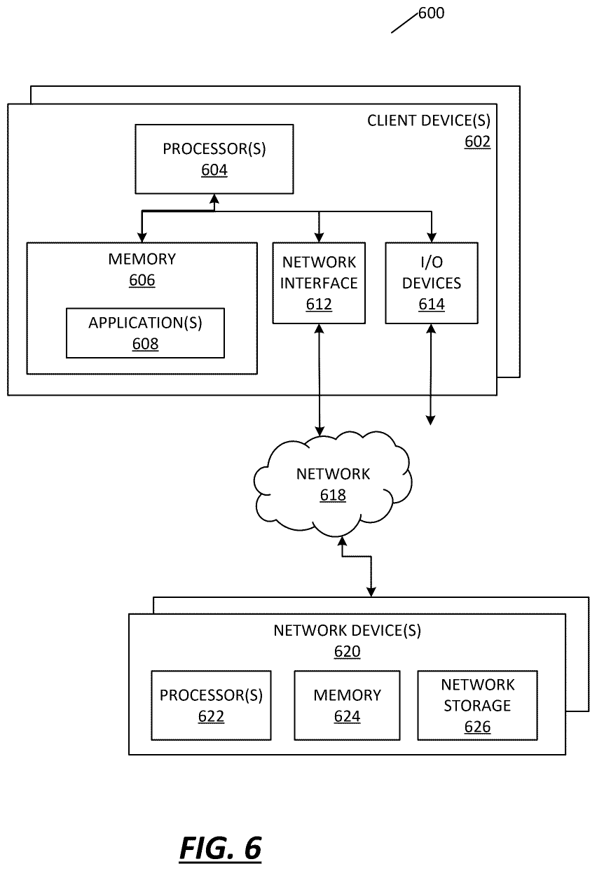

FIG. 6 shows an example of a hardware system for implementation of the intelligent order system in accordance with the disclosed embodiments. FIG. 6 depicts a network diagram 600, including one or more client devices 602 connected to one or more network devices 620 over a network 618. Client device(s) 602 may comprise a personal computer, a tablet device, a smart phone, network device, or any other electronic device which may be used to request an order or review order information. The network 618 may comprise one or more wired or wireless networks, wide area networks, local area networks, enterprise networks, short range networks, and the like. The client device(s) 602 can communicate with the one or more network devices 620 using various communication-based technologies, such as Wi-Fi, Bluetooth, cable connections, satellite, and the like. Users of the client device(s) 602 can interact with the network devices 620 to access services controlled and/or provided by the network devices 620.

Client device(s) 602 may include one or more processors 604. Processor(s) 604 may include multiple processors of the same or different type and may be configured to execute computer code or computer instructions, for example, computer readable code stored within memory 606. For example, the one or more processor(s) 604 may include one or more of a central processing unit (CPU), graphics processing unit (GPU), or other specialized processing hardware. In addition, each of the one or more processors may include one or more processing cores. Client device(s) 602 may also include a memory 606. Memory 606 may each include one or more different types of memory, which may be used for performing functions in conjunction with processor(s) 604. In addition, memory 606 can include one or more of transitory and/or non-transitory computer readable media. For example, memory 606 may include cache, ROM, RAM, or any kind of computer readable storage device capable of storing computer readable code. Memory 606 may store various programming modules and applications 608 for execution by processor(s) 604. Examples of memory 606 include magnetic disks, optical media such as CD-ROMs and digital video disks (DVDs), or semiconductor memory devices.

Client device(s) 602 also includes a network interface 612 and I/O devices 614. The network interface 612 may be configured to allow data to be exchanged between client device(s) 602 and/or other devices coupled across the network 618. The network interface 612 may support communication via wired or wireless data networks. Input/output devices 614 may include one or more display devices, keyboards, keypads, touchpads, mice, scanning devices, voice or optical recognition devices, or any other devices suitable for entering or retrieving data by one or more client device(s) 602.

Network device(s) 620 may include similar components and functionality as those described in client device(s) 602. Network device(s) 620 may include, for example, one or more servers, network storage devices, additional client devices, and the like. Specifically, network device(s) 620 may include a memory 624, network storage 626, and/or one or more processors 622. The one or more processor(s) 622 can include, for example, one or more of a central processing unit (CPU), graphics processing unit (GPU), or other specialized processing hardware. In addition, each of the one or more processor(s) 622 may include one or more processing cores. Each of memory 624 and network storage 626 may include one or more of transitory and/or non-transitory computer readable media, such as magnetic disks, optical media such as CD-ROMs and digital video disks (DVDs), or semiconductor memory devices. While the various components are presented in a particular configuration across the various systems, it should be understood that the various modules and components may be differently distributed across the network.

According to some embodiments, limited user information may be used to perform techniques described herein. For example, limited personal information may be collected as required to generate orders at the request of the user. It should be understood that the privacy of individuals who use the intelligent order system and the Al tools described herein is protected under relevant privacy policies. In some embodiments, user information may be collected upon agreement of the end user to participate in such efforts in accordance with the relevant privacy policies.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

1. A method of determining a vehicle value estimate of a vehicle, the method comprising:
obtaining assessment input data comprising vehicle data associated with a vehicle and target assessment data comprising a future target assessment date; and
applying the assessment input data to a vehicle assessment model, the vehicle assessment model comprising:
a weighted vehicle attribute predictor model,
a weighted vehicle value predictor model, and
a macroeconomic data predictor model,
wherein the vehicle assessment model generates a refined vehicle value prediction for the future target assessment date by:
applying the target assessment data to the weighted vehicle attribute predictor model to obtain a first output comprising a predicted set of vehicle attributes determined to be relevant to the target assessment date;
applying the target assessment data to the weighted vehicle value predictor model to obtain a second output comprising an initial vehicle value prediction for the future target assessment date;
applying the target assessment data to the macroeconomic data predictor model to obtain a third output comprising macroeconomic prediction data for the future target assessment date;
determining a relative weight for each of the first output, the second output. and the third output based on the target assessment date;
generating a refined vehicle value prediction for the target assessment date based on a combination of the predicted set of vehicle attributes, the initial vehicle value prediction, and the predicted macroeconomic data, in accordance with the determined relative weights; and
generating a conversion probability for the future target assessment date based on the combination of the predicted set of vehicle attributes, the initial vehicle value prediction, and the predicted macroeconomic data, in accordance with the determined relative weights.

2. The method of claim 1, wherein the assessment input data comprises at least one of:
a vehicle identification number (VIN) of the vehicle, and mileage of the vehicle.

3. The method of claim 1, wherein the vehicle assessment model generates the refined vehicle value prediction based, in part, on a seasonality of training data for the vehicle assessment model.

4. The method of claim 1, wherein an output of the weighted vehicle attribute predictor model is weighted greater than an output of the weighted vehicle value predictor model.

5. The method of claim 1, wherein an output of the weighted vehicle value predictor model is weighted greater than an output of the macroeconomic data predictor model.

6. The method of claim 1, wherein an output of the weighted vehicle value predictor model is based at least in part on at least one of vehicle depreciation, historical vehicle attributes associated with other vehicles, market performance of the other vehicles, seasonality of assessments of the other vehicles, an assessment location of other vehicles, and target assessment date of the other vehicles.

7. The method of claim 1, wherein an output of the macroeconomic data predictor model is based at least in part on one or more factors from a group consisting of petroleum prices, auto inventory, consumer price index for preowned vehicles, an average preowned vehicle loan amount, and net purchases of preowned vehicles.

8. A non-transitory computer readable medium comprising computer readable code executable by one or more processors to:
obtain assessment input data comprising vehicle data associated with a vehicle and target assessment data comprising a future target assessment date; and
apply the assessment input data to a vehicle assessment model, the vehicle assessment model comprising:
a weighted vehicle attribute predictor model,
a weighted vehicle value predictor model, and
a macroeconomic data predictor model,
wherein the vehicle assessment model generates a refined vehicle value prediction for the future target assessment date by executing computer readable code to:
apply the target assessment data to the weighted vehicle attribute predictor model to obtain a first output comprising a predicted set of vehicle attributes determined to be relevant to the target assessment date;
apply the target assessment data to the weighted vehicle value predictor model to obtain a second output comprising an initial vehicle value prediction for the future target assessment date;
apply the target assessment data to the macroeconomic data predictor model to obtain a third output comprising macroeconomic prediction data for the future target assessment date;
determine a relative weight for each of the first output, the second output, and the third output based on the target assessment date;
generate a refined vehicle value prediction for the target assessment date based on a combination of the predicted set of vehicle attributes, the initial vehicle value prediction, and the predicted macroeconomic data, in accordance with the determined relative weights; and
generate a conversion probability for the future target assessment date based on the combination of the predicted set of vehicle attributes, the initial vehicle value prediction, and the predicted macroeconomic data, in accordance with the determined relative weights.

9. The non-transitory computer readable medium of claim 8, wherein the assessment input data comprises at least one of:
a vehicle identification number (VIN) of the vehicle, and mileage of the vehicle.

10. The non-transitory computer readable medium of claim 8, wherein vehicle assessment model generates the refined vehicle value prediction based, in part, on a seasonality of training data for the vehicle assessment model.

11. The non-transitory computer readable medium of claim 8, wherein an output of the weighted vehicle attribute predictor model is weighted greater than an output of the weighted vehicle value predictor model.

12. The non-transitory computer readable medium of claim 8, wherein an output of the weighted vehicle value predictor model is weighted greater than an output of the macroeconomic data predictor model.

13. The non-transitory computer readable medium of claim 8, wherein an output of the weighted vehicle value predictor model is based at least in part on at least one of vehicle depreciation, historical vehicle attributes associated with other vehicles, market performance of the other vehicles, seasonality of assessments of the other vehicles, an assessment location of other vehicles, and target assessment date of the other vehicles.

14. The non-transitory computer readable medium of claim 8, wherein an output of the macroeconomic data predictor model is based at least in part on one or more factors from a group consisting of petroleum prices, auto inventory, consumer price index for preowned vehicles, an average preowned vehicle loan amount, and net purchases of preowned vehicles.

15. A system, comprising:
one or more processors; and
one or more non-transitory computer readable media comprising computer readable code executable by the one or more processors to:
obtain assessment input data comprising vehicle data associated with a vehicle and target assessment data comprising a future target assessment date; and
apply the assessment input data to a vehicle assessment model, the vehicle assessment model comprising:
a weighted vehicle attribute predictor model,
a weighted vehicle value predictor model, and
a macroeconomic data predictor model,
wherein the vehicle assessment model generates a refined vehicle value prediction for the future target assessment date by executing computer readable code to:
apply the target assessment data to the weighted vehicle attribute predictor model to obtain a first output comprising a predicted set of vehicle attributes determined to be relevant to the target assessment date,
apply the target assessment data to the weighted vehicle value predictor model to obtain a second output comprising an initial vehicle value prediction for the future target assessment date;
apply the target assessment data to the macroeconomic data predictor model to obtain a third output comprising macroeconomic prediction data for the future target assessment date;
determine a relative weight for each of the first output, the second output. and the third output based on the target assessment date;
generate a refined vehicle value prediction for the target assessment date based on a combination of the predicted set of vehicle attributes, the initial vehicle value prediction, and the predicted macroeconomic data, in accordance with the determined relative weights; and
generate a conversion probability for the future target assessment date based on the combination of the predicted set of vehicle attributes, the initial vehicle value prediction, and the predicted macroeconomic data, in accordance with the determined relative weights.

16. The system of claim 15, wherein the assessment input data comprises at least one of:
a vehicle identification number (VIN) of the vehicle, and
mileage of the vehicle.

17. The system of claim 15, wherein vehicle assessment model generates the refined vehicle value prediction based, in part, on a seasonality of training data for the vehicle assessment model.

18. The system of claim 15, wherein an output of the weighted vehicle attribute predictor model is weighted greater than an output of the weighted vehicle value predictor model.

19. The system of claim 15, wherein an output of the weighted vehicle value predictor model is weighted greater than an output of the macroeconomic data predictor model.

20. The system of claim 15, wherein an output of the weighted vehicle value predictor model is based at least in part on at least one of vehicle depreciation, historical vehicle attributes associated with other vehicles, market performance of the other vehicles, seasonality of assessments of the other vehicles, an assessment location of other vehicles, and target assessment date of the other vehicles.
